(19) United States
(12) Patent Application Publication
(10) Pub. No.: US 2005/0071809 A1
(43) Pub. Date: Mar. 31, 2005

(54) System and method for serializing objects in a compiled programming language

(76) Inventor: Greggory Pulley, Ault, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/675,355

(22) Filed: Sep. 29, 2003

(51) Int. Cl. G06F 9/44; G06F 17/00; G06F 7/00

(52) U.S. Cl. 717/108; 707/103 R

(57) ABSTRACT

A system and method is provided for serializing objects in a compiled programming language. The method includes the operation of creating a storage agent for a serializable object, and the storage agent is configured to construct instances of the serializable object. A serializable object name and an associated storage agent pointer are registered in a type map for each serializable object, and the storage agent pointer links to the corresponding storage agent. The serializable object is stored with the serializable object name and object data on an electronic storage medium. The serializable object's storage agent is identified by using the serializable object name to index into the type map when the serialized object is read from the electronic storage medium. A further operation is constructing a serializable object instance using the storage agent. The serializable object instance can then be loaded with the object data read from the electronic storage medium to restore the serialized object.

### FIELD OF THE INVENTION

The present invention relates generally to serializing objects in a compiled programming language.

### BACKGROUND

The development of application and system software for computer systems has traditionally been a time-consuming task. The field of software engineering has attempted to overcome the limitations of traditional techniques by proposing more efficient software development models. Object-oriented programming has emerged as one technology that allows relatively rapid development, implementation and customization of new software systems. Another aim of object-oriented programming is to design computer software with objects that are reusable and cost effective to modify.

Object-oriented programming can use a tool kit of pre-designed objects and programmer created objects that may be assembled to perform a final task. Each object has certain data attributes and methods (or functions) that operate on the data. Data is described as being “encapsulated” by an object and the data can be modified or accessed by the object methods. The object methods typically operate on private data such as instance data or object state data that the object owns. Methods or functions are invoked by sending a message to an object identifying the method and supplying any needed data arguments.

An object class acts as a type of stencil that describes the behavior of objects. An object's implementation is often encapsulated and hidden from public view. Objects' private instance data is generally limited to access by object methods which are private to the object class. Object public instance data is accessed through a public object interface.

Object-oriented systems have important properties in addition to encapsulation. “Inheritance” is the ability to derive a new object from an existing object and inherit all its properties, including methods and data structures from the existing object (i.e., the parent). The new object may have certain additional features that are supplied as overrides or modifications to the existing class. For example, a new subclass specifies the additional functions and data members that distinguish that new class from the more general existing class.

A parent class can also include what is known as a virtual method. A virtual method is a prototype of a method that can be implemented by a class that inherits from the parent or base class. Virtual functions allow a programmer to create concrete methods in a subclass that match the virtual method name and such functions also allow a user to overload a method.

The ability to overload an existing method description is termed “polymorphism” because a single message to an object's method or operator can be processed in different ways depending on the object arguments being used to call the method. Inheritance and polymorphism create an extendable structure for implementing flexible software systems. The software developer can avoid constructing some pieces of a new system because the developer can just specify the unique features of the new system.

Program objects created by a computer program are typically maintained in the volatile memory of the computer system. This enables faster processing, but does not provide a way to store an entire program object in nonvolatile storage. Program data is frequently written to a nonvolatile storage device but storing program objects in their executing state is more problematic. Some object-oriented systems solve this problem by implementing persistent objects. One recent method in the object-oriented programming world for storing a program object in a nonvolatile storage device with its run-time state is called object serialization.

Object serialization provides a program with the ability to read or write a whole object to and from a raw data stream. It allows objects and primitives to be sent to a data stream suitable for streaming to a network, file-system, or more generally, to a transmission medium or storage device. For example, the data stream containing the serialized objects can be written to a hard drive or sent across the Internet to another computer.

At first glance, serialization may sound like a powerful feature or a fairly insignificant one. Serialization of objects is valuable considering the tasks that can be made easier and the features that can be added to software with serialization. Part of the power of serialization is the ability of programs to easily read and write entire objects and primitive data types to a data stream without writing additional program code for converting to and from raw bytes or parsing clumsy text data.

Anyone who has taken a programming class taught in a programming language such as C, has surely had the opportunity to do I/O to a text file for the purpose of storing and loading data. The parsing of these files seems to reduce to a basic set of hurdles that the programmer must surmount such as: testing for the end of file (EOF) marker, testing whether the file pointer is on top of the integer or the string, testing for the end of line (EOLN) marker, and testing whether the marker is missing. Object serialization provides a programmer with the tools to store entire objects instead of reading and writing an object's state in some foreign and possibly unfriendly format.

In object-oriented programming, the permanence of an object is also relevant in the context of object-oriented databases, which maintain a distinction between objects created for the duration of execution and those intended for permanent storage. Thus, persistence means that the object's state can be preserved beyond the termination of the process that created the object. Objects can be stored individually or grouped with other objects. Further, objects can be sent across a network to a second copy of the same program running on another computer.

Serialization has been used in the past in a number of programming environments. One specific programming environment where serialization has been used is in the interpreted Java® programming language. Including serialization in the Java(g) programming language is a straightforward process because the run-time type information (RTTI) is carried with every object at run time. In order to serialize in Java®, the objects are written out with their run-time information and then when they are read back in from the storage medium, the run-time information is used to rebuild the run-time data object. Java® includes the RTTI in the run-time environment because of its interpreted nature. Unfortunately, this simplistic model for serialization is generally not possible for a compiled programming language because compiled languages do not store the RTTI with the objects at run time.

Those who have made attempts to implement serialization in a compiled programming language, such as C++, have had limited results. The previous implementations of serialization in a compiled language have provided serialization systems with reduced functionality or significant drawbacks.

An example of serialization in the compiled C++ programming language is the inclusion of serialization in Microsoft Corporation's Foundation Class. Microsoft's serialization is a limited function serialization that is primarily intended for use with simple text document classes within the Foundation Class object environment. In order to simplify the re-loading and identification of the serialized objects, Microsoft has limited the types that can be used in serialization. Specifically, these types are limited to some pre-provided types that come with the programming language. Then in order to re-instantiate or recover a serialized object, a dynamic casting is used with the class name in a huge switch statement to do an exhaustive search for the correct object type when the serialized object is restored.

The significant drawback to Microsoft's system is that this system provides just a small number of known serializable object classes within the programming language. Objects that have been “hard coded” by Microsoft into the switch statement are serializable but user defined objects are not. This is useful if a programmer desires to serialize objects that are included with the programming language, but it does not provide any flexibility or extensibility of the serialization functions.

Another prior serialization method has provided object serialization or persistent storage of a compiled C++ object using debug information. In this method, the compiler debug information is linked with RTTI engine that is used at run time for the programming language. When an object is serialized, the RTTI information is extracted and saved with the object. This is similar to the Java® model. Although this method provides a serializable object, it does so at the huge expense of speed in the final compiled executable. The speed of the final compiled executable will be much slower because all the debug information remains within the executable. A further serious disadvantage of this method is that it increases the size of the final compiled executable because the compiler leaves the debug information in the executable. These drawbacks are generally problems that most programmers try to avoid in the final executable. Both of the methods described above for serializing in a compiled language provide significant limitations and clumsiness in the serialization implementation.

### SUMMARY OF THE INVENTION

The invention provides a system and method for serializing objects in a compiled programming language. The method includes the operation of creating a storage agent for a serializable object, and the storage agent is configured to construct instances of the serializable object. A serializable object name and an associated storage agent pointer are registered in a type map for each serializable object, and the storage agent pointer links to the corresponding storage agent. The serializable object is stored with the serializable object name and object data on an electronic storage medium. The serializable object's storage agent is identified by using the serializable object name to index into the type map when the serialized object is read from the electronic storage medium. A further operation is constructing a serializable object instance using the storage agent. The serializable object instance can then be loaded with the object data read from the electronic storage medium to restore the serialized object.

### BRIEF DESCRIPTION OF THE DRAWINGS

FIG. 1 is a flow chart illustrating a method for serializing objects in a compiled programming language in an embodiment of the invention;

FIG. 2 is a block diagram illustrating a simplified view of object information that can be written to a data stream in accordance with an embodiment of the present invention;

FIG. 3 illustrates one possible data structure for one or more serialized objects;

FIG. 4 is a flow chart illustrating a simplified view of the operations used when a serialized object is restored in an embodiment of the invention; and

FIG. 5 is a block diagram illustrating an embodiment of a detailed relationship between program components that operate to restore a serialized object.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

The present invention is a system and method for serializing objects in a compiled programming language. For example, the target programming language can be C++, object oriented Pascal, or any similar compiled language. This serialization invention allows in-memory objects with state to be saved as a block onto a stream and enables the restoring of previously serialized objects.

As discussed previously, prior serialization methods for compiled languages have several problems. Part of the reason that prior serialization methods for compiled languages have been very limited and unwieldy is because compiled languages, such as C++, Pascal, etc., do not have the general ability to create an object or class on the fly without knowing what the object is at compile time. In other words, there is no such thing as a dynamic constructor because compiled languages do not store object run-time type information (RTTI) with an executable because of the overhead involved.

In order to provide serialization, the present invention includes the ability to instantiate or construct arbitrary types as needed. However, the “new” operator in languages such as C++ or Pascal can only create an explicit type. This is generally related to the “hidden pointer problem” as described in the current programming literature. Accordingly, the present invention provides a form of “virtual constructors” to enable serialization.

Another problem that the present invention solves is the ability to add serializable objects and classes as desired. Prior serialization solutions have not been readily extensible. Software developers desire to easily add new serializable classes and objects. In addition, enabling serializable classes or objects is preferably straightforward and uncomplicated. In one embodiment of this serialization invention, the source code for the serializable objects and classes can be provided in the class definition (.H file) and/or implementation.

Another problem that the present serialization invention addresses is the fact that objects can be created by reference (one copy pointed to by another object via pointers), or by value (nesting). The present invention has to manage both of these cases. This is the “hidden pointer problem” described in current programming literature.

In order to provide a clearer description of the present invention, a high level overview of a method and system for serializing objects in a compiled programming language will be presented and then more technical details will be discussed later. The serializer of the present invention solves these problems discussed above by using a map with automatic type registration and an implementation of virtual constructors based on these registered types.

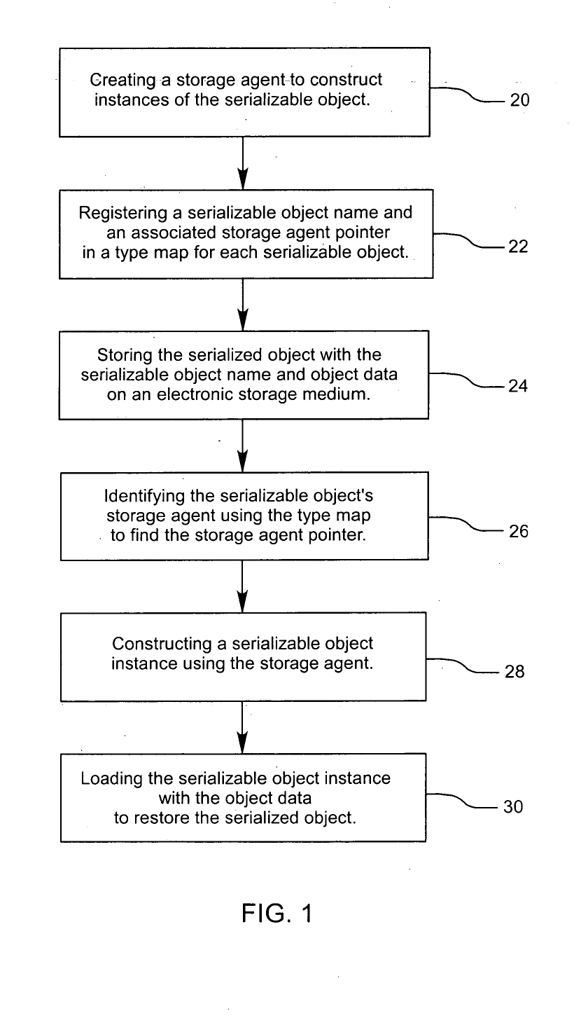

FIG. 1 illustrates that one embodiment of the serialization method includes the operation of creating a storage agent for a serializable object in block 20. The storage agent is configured to construct instances of the serializable object when requested by the serialization system. Another step is registering a serializable object name and an associated storage agent pointer in a type map for each serializable object in block 22. The type map contains a one-to-one mapping between the serializable object name and storage agent pointer. The mapping may be stored in a vector object or the mapping may be some other type of custom one-to-one mapping object. The storage agent pointer refers to the corresponding storage agent and links the serializable object name to the storage agent. As will become more apparent later, this links the object's run-time type information (RTTI) to the “virtual constructor”.

The dynamic mapping scheme allows a particular object type to be created when serialized object information is read from a file. This mapping cannot be “hard coded” into the serialization system because software developers frequently add new object types and classes to a program. In addition, the mapping is needed to properly handle typedefs and other similar other object definitions.

Once the mapping is set up, then the serialized object can be stored with the serializable object name and object data on an electronic storage medium in block 24. The electronic storage medium may be any type of I/O (input/output) stream that can be used by the programming environment. For example, the serializable object can be written to an output stream or electronic storage medium that is a local hard drive, network storage system, a network socket, a peripheral device, a virtual device or any another device that can return the data stream upon request to the program performing the serializing. The serializable object may remain on the electronic storage medium as long as desired by the computer program, software developer, or computer system user. Later, the serialized object can be read from the electronic storage medium at the request of the program or user.

When the program begins to read the serialized object(s) back into the program, then the operation will be performed of identifying the serializable object's storage agent by looking up the serializable object name in the type map to find the storage agent pointer in block 26. A serializable object instance can be constructed using the storage agent in block 28. The storage agent is a named storage agent that can create serializable object instances for the object or class with which the storage agent is associated. Specifically, the named storage agent can call the given object's constructor using the “new” operator.

In order to create a storage agent, a source code template is used for each class, so that the storage agent can create the class or object that is passed to the source code template at compile time. After the serializable object instance has been created, the serializable object instance is loaded with the object data read from the electronic storage medium to restore the serialized object in block 30.

Now that the invention has been described in a general manner, the invention will be described as it can be implemented for a specific compiled language in particular. To make a class or object serializable, the class should be derived from the system's serializable class because the serializable class has access to the needed functions and pointers for serialization. In addition, each serializable class has a public default constructor to allow the class or object to be un-serialized by reference. This is because the public constructor for the serializable class will be called by the storage agent.

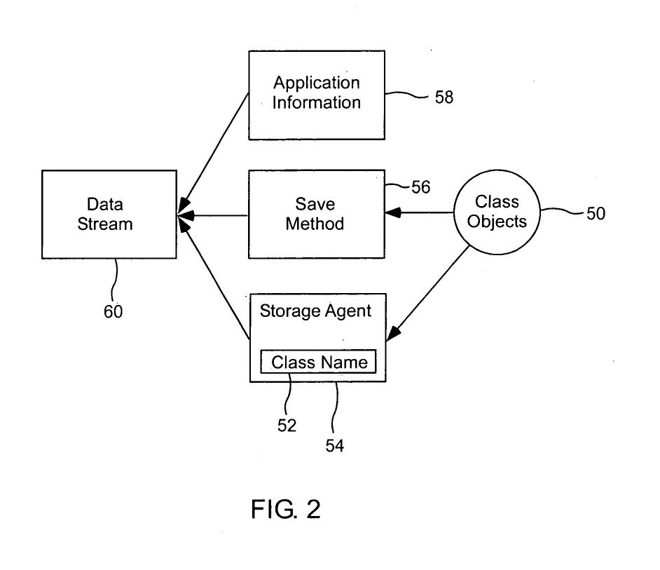

FIG. 2 is a block diagram illustrating a method for object output. One or more objects 50 or classes can be serializable and the program may request that the objects be serialized at some point. In order to serialize the objects, a storage agent 52 or similar data construct is used to store the class name 54 or object name of each serializable object. Since each serializable object has its own static storage agent (or named storage agent), the serialization system is able to ask the object or class to return the object's name using the storage agent and then the object or class name can be written out to the data stream 60. The storage agent can store the object name in a string and return the object name through a function. (Footnote: a static data structure is a storage location that is shared by every instance of a specific class.)

The use of a storage agent overcomes the lack of a dynamic constructor, because the storage agent includes the object factory for a given object type or class. This object factory in the storage agent is created at compile time using source code templates. The object factory include a “new <object>” function call that returns a new object, where the <object> name is inserted for each class or object by the template. The point is that the object factory can be called at run time when the object is read back in.

Furthermore, this serialization invention uses storage agents to keep track of the classes or objects that are serialized. A mapping object (not shown in FIG. 2) is used to correlate the actual class or object names to their respective storage agents. An example of mapping object is a standard template library (STL) map object or a vector. The storage agent is later used to manufacture the object being un-serialized using the object factory just before a restore( ) function is called for the object.

When the object is saved to the data stream 60, there are a number of items that are saved in addition to the class or object name. Particularly, application information 58 is saved to the data stream. A save method 56 that has been created for a given class or object is also called when the object is saved. The save method writes the data attributes (or stored variables) for a given class or object out to the data stream. Each serializable object includes save and restore member functions that are called to serialize the object's state and write it to or read it from an archive object in an electronic storage location. In one specific implementation, the programmer for any class derived from the serializable subclass is responsible for implementing the virtual save( ) and restore( ) member functions that are inherited from the serializable class.

In a programming language that supports this serialization invention, at least one archive module or data construct will support the reading and writing of objects to the data stream. For example, in an embodiment of the invention in the C++ language, an archive module can be provided that is separated into two classes. Particularly, an input archive and an output archive can be provided. Data may be serialized to and from an archive with the <<operator and the>> operator in a manner that is much like iostream class in C++. However, the object data streams are the most straightforward to work with in a binary data format and so an efficient implementation this invention can read and write in a binary data format. As in an iostream, there may be implementations of the invention that read and write fundamental data types such as “long” and “char” by default.

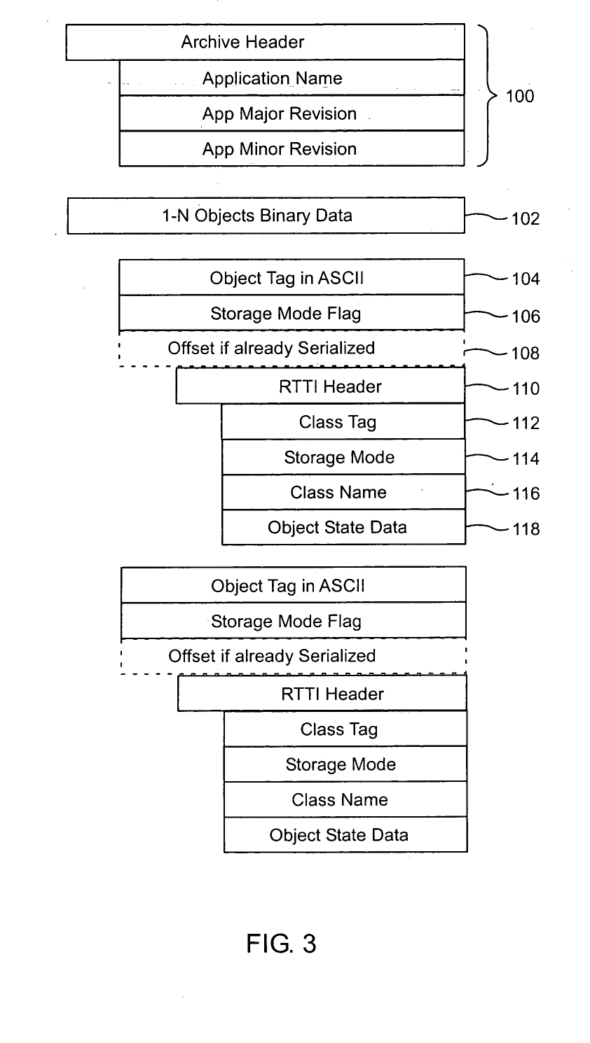

FIG. 3 illustrates one possible format in which the object archive for the serialized objects may be organized and stored. The beginning of the file includes the archive header which designates the file as an object archive. Following the archive header is the application name, application major revision number, and the application minor revision number 100. Following the header and application information will be one or more serialized objects. The objects can be separated from the header by a binary data marker 102 or the object information may simply follow the header information. The object binary data marker may also contain the number of objects written to the archive for error checking purposes.

Each object can include an object tag 104 that is stored in ASCII format. The object tag may be stored as an “O” which represents that an object is being stored. Other object tags can be used for different object types such as a primitive object or a group of objects that might be stored. The object tag enables the type of objects that may be stored to be extended by incorporating new character tags.

A storage mode flag 106 is provided that represents whether the object will be stored by value or by reference. For example, a “V” can be stored in the storage mode flag if the object is stored by value or an “R” can be stored if the object is stored by reference. If the object has been stored already and this is just a reference or pointer to the previously stored object, then an offset 108 to the object in the archive can be stored.

A run-time type (RTTI) header 110 or marker can be stored with each object to designate the beginning of the run-time object data. Following the RTTI header is a class tag 112 that represents the class type or that a class is being stored. For example, a “C” can be stored in this field to represent the storage of a class and other identifiers can be stored here when other objects or specialized class types are being stored. A storage mode 114 is contained in the RTTI data section. The storage mode indicates whether the object was stored by value or by reference and this enables the archive class to determine whether the object was stored on the heap or auto templated. A class name 116 is stored and later used to construct a concrete instance of the object using the appropriate storage agent. Finally, the object state data 118 is stored in the object archive, and the state data is written out by the serializable object's overridden save method. As mentioned, the restore method can be later called to read the serializable object state information back into an object instance created by the serialization system. Although the object archive has been described in a particular order, it should be realized the order of elements may vary and some elements may be added or omitted without detracting from the invention.

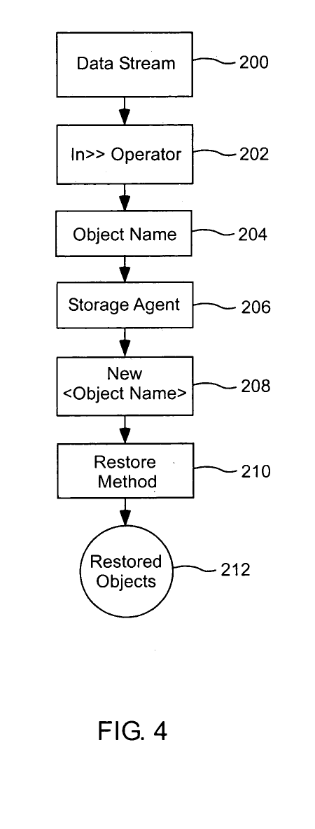

FIG. 4 illustrates an overview of the operations that take place for recreating or restoring serializable objects in a compiled programming language. An initial operation is reading a serializable object from an electronic data stream where the serializable object has been stored as in block 200. The object information may be read in using an input operator, such as the overloaded>> in the C++ language in block 202. When the object information is read in, this includes receiving an object or class name (i.e., RTTI) with the serializable object in block 204. The object name or class name is used to find a named storage agent for the serializable object in block 206. This is done by searching a mapping of the class names to the storage agents. This mapping is a one-to-one mapping and may be performed using a dynamic vector object which contains the class names associated with pointers to the storage agents. This mapped type information enables the serialization system to reconstruct the correct object type when a polymorphic pointer is used to serialize an object by reference. Other mapping objects or systems for use in the present invention may also be devised by those skilled in the art.

Once the corresponding storage agent has been found, then a new instance of the serializable object is created using the named storage agent in block 208. A further operation is calling the object's restore method to load serialized state data or object attributes from the electronic data stream into the new instance of the serializable object in block 210. These operations can restore one object or multiple objects depending on the number requested by the computer program in block 212.

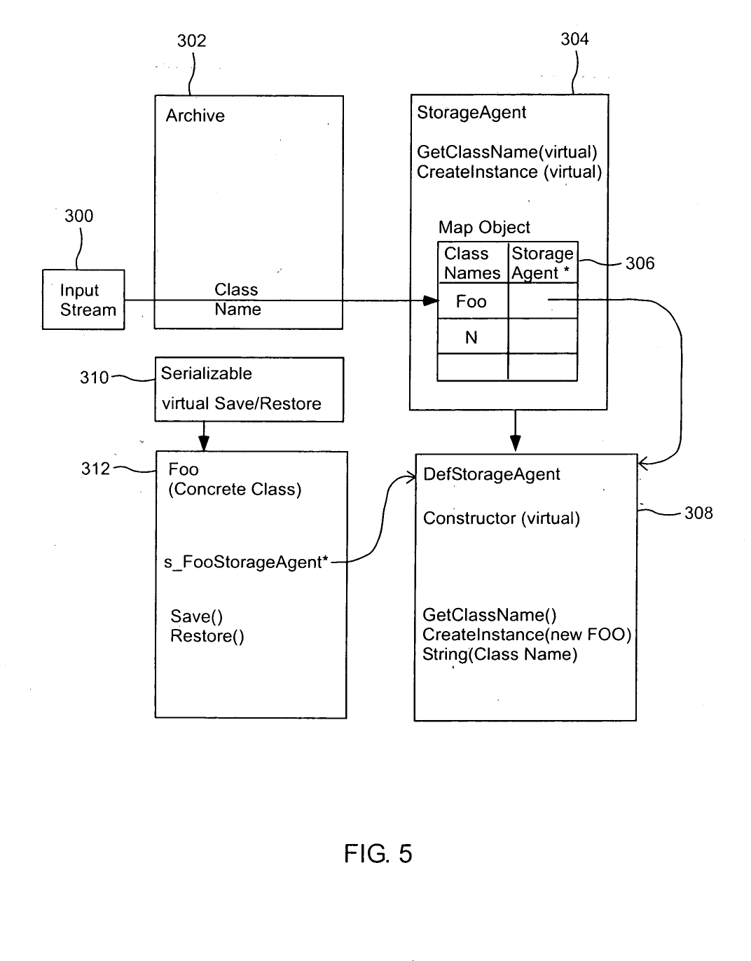

FIG. 5 illustrates one embodiment of the invention as it may be implemented using a number of object oriented classes. Other embodiments of the invention are not restricted to the programmatic configuration illustrated in FIG. 5. When an object is being restored, the object is read from an input stream 300. One element that will be read by the input archive 302 from the input stream is the class name. Although the present discussion describes the use of a class name, an object identifier or some other unique identifier can be used in place of the class name.

The class name is searched for or hashed into a map object 306 which maps the class names to the corresponding storage agent pointer. The example class name in the figure is “Foo”. The storage agent pointer references the named storage agent 308 (or defined storage agent) that knows how to create a concrete instance of the object being read. This storage agent pointer is passed back to the archive object 302 which is able to call the CreateInstance method or function in the named storage agent 308. The CreateInstance method includes a “new” or run-time allocation statement to construct a concrete instance of class being restored. The CreateInstance function is generated by a source code template at compile time.

Once the archive object 302 has made the call to the storage agent to construct the concrete class, then the archive object uses a pointer to the concrete class to call the restore method contained in the class 312. The correct method is called because the virtual restore method in the serializable class 310 has been overridden in the concrete class 312 (e.g. the Foo class) that inherits from serializable class. Calling the restore method loads all of the data attributes or members for the class or object and restores the state of the object at the time the object was saved.

In order to bind the serializable derived classes together with the named storage agent at compile time, the serializable derived classes can incorporate macros with source code and template source code into the serializable derived classes. In one embodiment of the invention, two macros named DECLARE_SERIALIZABLE(<classname>) and IMPLEMENT_SERIALIZABLE(<classname>) can be used to bind a class or object to its storage agent and register the class in the mapping object. These macros create the named storage agent and enter the class name and pointer to the named storage agent into the map object. An internal typedef can be used in the serializable-derived application classes for object tags or object/class ids to ensure a standard format.

The DECLARE_SERIALIZABLE macro enables objects of serializable derived classes to be created dynamically at run time. After preprocessing, the DECLARE_SERIALIZABLE macro expands adding new class members to the serializable-derived class. One possible implementation of the DECLARE_SERIALIZABLE is listed here:

```
#define DECLARE_SERIALIZABLE(type) \
public: \
  StorageAgent* getStorageAgent( ) const
  { return s_##type##StorageAgent; } \
  static StorageAgent* s_##type##StorageAgent
```

The first member is getStorageAgent( ), a member function used to build a type string for the StorageAgent that is needed to restore( ) the class. The StorageAgent class name is prefixed by the class name using the macro-concatenation operator (##). The second element adds a base pointer to the StorageAgent used to reconstruct this class.

The StorageAgent::getClassName( ) virtual function is the basis for RTTI in the serialization invention. The use of a polymorphic pointer lets us create/restore a concrete object type even with a pointer to a generic serializable object.

As discussed, the CreateInstance( ) virtual function forms the basis of the serialization object factory that can construct types on demand at run time that have been templated in the source code at compile time. To understand the workings of CreateInstance( ) in detail, some background may be necessary. The virtual constructor of the present invention is used when the object type needs to be determined from the context in which the object is constructed.

In this serialization invention, the context is based on information read from the serialized archive stream. However, a virtual constructor does not exist in a compiled language. For example, no C++ language syntax implements a virtual constructor directly. In other words, the new operator needs an explicit class as its argument. The present invention creates a virtual constructor by implementing in each class a static function that calls the new operator. This static member function can be called when a particular type is needed.

In one embodiment of the serialization invention, this member function is called DefStorageAgent::createInstance( ). The StorageAgent 304 is bound to the serializable derived object using the IMPLEMENT_SERIALIZABLE macro. This macro can be incorporated in a .cpp source code implementation module for each class supporting serialization. IMPLEMENT_SERIALIZABLE takes the name of the class as a single argument and instantiates the class-specific DefStorageAgent responsible for each serializable derived class.

For example, when a FOO type is needed, the CreateInstance( ) member function is called for the FOO class' StorageAgent. CreateInstance( ) then allocates the memory using the named storage agent's template created function. Thus any type that can be allocated using the new operator can be created via this compile-time binding.

By using the class map in the StorageAgent and the CreateInstance( ) member function, this serialization invention is able to lookup and create types on the fly. This is valuable because it creates a virtual constructor for any type that a software developer desires to serialize. Here is an example definition of the IMPLEMENT_SERIALIZABLE macro:

#define IMPLEMENT_SERIALIZABLE(type) \
static DefStorageAgent<type> type##StorageAgent(string(#type)); \
StorageAgent* type::s_##type##StorageAgent = & type##StorageAgent

It is also valuable to provide an example definition of the template provided in the storage agent to create the named storage agents.

```
template< class T> class DefStorageAgent : public StorageAgent
{
public:
  DefStorageAgent (const string& className) :
  StorageAgent(className) { }
  virtual ˜DefStorageAgent ( ) { }
  virtual Serializable* CreateInstance( ) { return new T; }
};
```

As can be seen in this example code segment, the named storage agent is created for a given class and that class name is passed in to the template to create the CreateInstance function which can generate and return the type for which the template was created. For example, if the defined storage agent is created for the FOO class, then at compile time FOO is inserted for T which creates a callable function to override the virtual CreateInstance created in the parent StorageAgent class.

It is to be understood that the above-referenced arrangements are illustrative of the application for the principles of the present invention. Numerous modifications and alternative arrangements can be devised without departing from the spirit and scope of the present invention while the present invention has been shown in the drawings and described above in connection with the exemplary embodiments(s) of the invention. It will be apparent to those of ordinary skill in the art that numerous modifications can be made without departing from the principles and concepts of the invention as set forth in the claims.

1. A method for serializing objects in a compiled programming language, comprising the steps of:
creating a storage agent for a serializable object that is configured to construct instances of the serializable object;
registering a serializable object name and an associated storage agent pointer in a type map for each serializable object, wherein the storage agent pointer links to the corresponding storage agent;
storing the serializable object with a serializable object name and object data on an electronic storage medium;
identifying the serializable object's storage agent by using the serializable object name to index into the type map when the serialized object is read from the electronic storage medium;
constructing a serializable object instance using the identified storage agent; and
loading the serializable object instance with the object data read from the electronic storage medium to restore the serialized object.

2. A method as in claim 1, wherein the step of identifying the serializable object's storage agent further comprises the step of matching the serializable object name read back from the electronic storage medium with the storage agent pointer of a serializable object using the type map.

3. A method as in claim 2, further comprising the step of recreating an object type with the storage agent using a template generated method to create an instance of the serializable object.

4. A method as in claim 1, wherein the step of registering the serializable object in a type map further comprises the step of storing the serializable object names and their associated storage agent pointers in a custom map data structure.

5. A method as in claim 1, wherein the step of registering the serializable object in a type map further comprises the step of using a dynamic vector as the type map.

6. A method as in claim 1, wherein the step of registering a serializable object name further comprises the step of storing serializable object names in the type map that are set by an application programmer using the source code.

7. A method as in claim 1, wherein the step of creating a storage agent for a serializable object further comprises the step of creating a storage agent for a serializable class.

8. A method as in claim 1, wherein the step of creating a storage agent for a serializable object further comprises the step of creating a static storage agent for a serializable class.

9. A method as in claim 1, wherein the step of creating a storage agent for a serializable object further comprises the step of creating a storage agent having an object factory for creating instances of the serializable object.

10. A method for recreating a serializable object in a compiled programming language, comprising the steps of:
reading a serializable object from an electronic data stream where the serializable object has been stored;
receiving an object name with the serializable object;
finding a named storage agent for the serializable object based on the object name received for the serializable object;
creating a new instance of the serializable object using the named storage agent;
calling a restore method to load serialized data for the serializable object from the electronic data stream into the new instance of the serializable object.

11. A method as in claim 10, wherein the step of creating a new instance of the serializable object using the named storage agent further comprises the step of creating a new instance of the serializable object to restore an object stored by reference.

12. A method as in claim 10, further comprising the step of creating a named storage agent for the serialized object based on an object name of the serialized object.

13. A method as in claim 12, further comprising the step of identifying serializable object names set by an application programmer at compile time and creating named storage agents for the serializable object names.

14. A method as in claim 10, wherein the step of finding a named storage agent for the serializable object further comprises the step of finding a named storage agent using a type map which stores the object name associated with a pointer to the corresponding named storage agent.

15. A method as in claim 13, further comprising the step of accessing the pointer to the named storage agent to call a function that creates a serializable object corresponding to the object name.

16. A method as in claim 10, wherein the step of finding a named storage agent for a serializable object further comprises the step of finding a named storage agent for a serializable class.

17. A method as in claim 10, further comprising the step of creating a storage agent for a serializable object that is static.

18. A system for serializing objects in a compiled programming language, comprising:
a mapping object configured to store serializable object names and corresponding named storage agent pointers;
a named storage agent, referenced by the named storage agent pointer, being configured to create an instance of a serializable object when the serializable object is restored;
a parent storage agent object configured to operate on the mapping object and to provide virtual functions for the named storage agent; and
an archive object in communication with the parent storage agent and the named storage agent, the archive object being configured to save and restore the serialized object.

19. A system as in claim 18, wherein the mapping object enables the archive object to create new instances of serializable objects using the named storage agent and to restore an object's state into the new instances of serializable objects.

20. A system as in claim 18, wherein the archive object further comprises an output stream object to write the serializable object to an output stream.

21. A system as in claim 18, wherein the archive object further comprises an input stream object to read the serializable object from an input stream.

22. A system as in claim 18, wherein the serializable object names are entered into the mapping object as set by an application programmer at compile time.

23. A system as in claim 18, wherein a serialized object further comprises an archive header including an application name, application major revision, and an application minor revision.

24. A system as in claim 18, wherein a serialized object further comprises a storage mode flag to indicate whether the serialized object is stored by value or stored by reference.

25. A system as in claim 18, wherein the serialized object further comprises run time type information that includes the serialized object's class name.

26. A system as in claim 18, further comprising an electronic file within which a plurality of serialized objects are stored.

27. A system for serializing objects in a compiled programming language, comprising:
a mapping object means for storing serializable object names and corresponding named storage agent pointers;
a named storage agent means, referenced by the named storage agent pointer, for creating an instance of a serializable object when the serializable object is restored;
a parent storage agent means for operating on the mapping object means and to provide virtual functions for the named storage agent means;
an archive object means in communication with the parent storage agent means and the named storage agent means, wherein the archive object means is for saving and restoring the serialized object; and
wherein the mapping object means enables the archive object means to create new instances of serializable objects using the named storage agent means and to restore an object's state into the new instances of serializable objects.
